(19) United States
(12) Patent Application Publication
(10) Pub. No.: US 2024/0287715 A1
(43) Pub. Date: Aug. 29, 2024

(54) FLAME-RETARDANT FABRIC AND WORK CLOTHING

(71) Applicant: KANEKA CORPORATION, Osaka (JP)

(72) Inventors: Wataru Kawauchi, Hyogo (JP); Keita Uchibori, Hyogo (JP)

(73) Assignee: KANEKA CORPORATION, Osaka (JP)

(21) Appl. No.: 18/585,807

(22) Filed: Feb. 23, 2024

(30) Foreign Application Priority Data
Feb. 24, 2023 (JP) 2023-027188

(51) Int. Cl. D04B 1/16; A62B 17/00; D02G 3/04; D02G 3/44; D04B 1/24

(52) U.S. Cl. CPC D04B 1/16; A62B 17/003; D02G 3/045; D02G 3/443; D04B 1/24; D10B 2201/24; D10B 2331/021; D10B 2401/04; D10B 2501/04

(57) ABSTRACT

A flame-retardant fabric includes 20% by mass or more and less than 40% by mass of silica-containing cellulose fibers, 25 to 55% by mass of flame-retardant cellulose fibers containing a phosphorus-based flame retardant, and 10 to 50% by mass of aramid fibers. The flame-retardant fabric is easy to dye and exhibits high flame retardancy in flammability tests. A work clothing contains the flame-retardant fabric.

### BACKGROUND

One or more embodiments of the present invention relate to a flame-retardant fabric containing cellulose fibers and aramid fibers, and work clothing containing the same.

Fabrics containing modacrylic fibers and the like are widely used as flame-retardant fabrics. For example, JP 2014-529690A (Tokuhyo) describes a fabric for use in arc and flame protection containing modacrylic fibers, FR rayon fibers, and aramid fibers. WO 2004/097088 describes that a fabric is manufactured using a flame-retardant fiber composite containing modacrylic fibers containing an antimony compound, heat-resistant fibers such as aramid fibers, and cellulose-based fibers.

JP 2014-529690A (Tokuhyo) and WO 2004/097088 are examples of related art.

However, for the fabrics described in JP 2014-529690A (Tokuhyo) and WO 2004/097088, although cellulose-based fibers and aramid fibers can be dyed with reactive dyes, modacrylic fibers cannot be dyed with reactive dyes and the dyeing process is complicated.

### SUMMARY

In order to solve the above, one or more embodiments of the present invention provide a flame-retardant fabric that is easy to dye and exhibits high flame retardancy in flammability tests, and work clothing containing the same.

One or more embodiments of the present invention relate to a flame-retardant fabric containing 20% by mass or more and less than 40% by mass of silica-containing cellulose fibers, 25 to 55% by mass of flame-retardant cellulose fibers containing a phosphorus-based flame retardant, and 10 to 50% by mass of aramid fibers.

One or more embodiments of the present invention relate to work clothing containing the flame-retardant fabric mentioned above.

According to one or more embodiments of the present invention, it is possible to provide a flame-retardant fabric that is easy to dye and exhibits high flame retardancy in flammability tests, and work clothing containing the same.

### DETAILED DESCRIPTION OF THE EMBODIMENTS

The inventor of one or more embodiments of the present invention made a series of studies to obtain a fabric that exhibits high flame retardancy and is easy to dye. As a result, it was found that, when aramid fibers, silica-containing cellulose fibers, and flame-retardant cellulose fibers containing a phosphorus-based flame retardant are used in combination and the amount of silica-containing cellulose fibers in the fabric is set to a predetermined range, a fabric that is easy to dye and exhibits high flame retardancy in flammability tests can be obtained. The flame-retardant fabric according to one or more embodiments of the present invention may have a char length of 20 mm or less as measured in a flammability test based on GB/T 5455-2014 defined in GB8965.1-2020. In this specification, GB means Chinese National Standard.

In this specification, if a numerical value range is indicated by “to”, the numerical value range includes both end values (upper and lower limits). For example, the numerical value range “A to B” is a range including both end values, A and B, and is the same range as “A or more and B or less”. In this specification, if a plurality of numerical value ranges are mentioned, the numerical range is regarded as being defined by an appropriate combination of one of the upper limits and one of the lower limits of the different numerical ranges.

The flame-retardant fabric according to one or more embodiments of the present invention contains silica-containing cellulose fibers, flame-retardant cellulose fibers containing a phosphorus-based flame retardant, and aramid fibers.

The silica-containing cellulose fibers may be any cellulose fibers containing silica and are not particularly limited, and may be either silica (SiO2)-containing natural cellulose fibers or silica-containing regenerated cellulose fibers. The natural cellulose fibers may be, for example, cotton, industrial hemp (including flax, ramie, jute, kenaf, hemp, manila hemp, sisal hemp, and New Zealand hemp), kapok, banana, palm, or the like. The regenerated cellulose fibers may be, for example, rayon fibers, cupra, lyocell, or the like. The silica-containing cellulose fibers may be used alone or in a combination of two or more.

The silica-containing cellulose fibers may be silica-containing regenerated cellulose fibers, or silica-containing rayon fibers, from the viewpoint of, for example, ease of dyeing, flame retardancy, and cost. The silica-containing rayon fibers may be, for example, commercially available silica-containing rayon fibers containing silica in fibers such as “Silica Rayon” manufactured by Shandong Helon Polytex Chemical Fiber Co., Ltd., China or “FR CORONA (registered trademark)” manufactured by Daiwabo Rayon Co., Ltd.

The silica-containing cellulose fibers may contain silica in an amount of 10% by mass or more, 13% by mass or more, or 15% by mass or more, from the viewpoint of flame retardancy. The silica-containing rayon fibers may contain silica in an amount of 30% by mass or less, 25% by mass or less, or 20% by mass or less, from the viewpoint of fiber strength and fabric strength. Specifically, the silica-containing cellulose fibers may contain silica in an amount of 10 to 30% by mass, 13 to 25% by mass, or 15 to 20% by mass. In this specification, the content of silica in the silica-containing cellulose fibers can be measured through SEM-EDS analysis.

The single fiber fineness of the silica-containing cellulose fibers is not particularly limited, and may be 1 to 20 dtex, or 1.5 to 15 dtex, from the viewpoint of strength. The fiber length of the silica-containing cellulose fibers is not particularly limited, and may be 38 to 127 mm, or 38 to 76 mm, from the viewpoint of strength.

The flame-retardant cellulose fibers may be any cellulose fibers containing a phosphorus-based flame retardant and are not particularly limited, and may be either natural cellulose fibers containing a phosphorus-based flame retardant or regenerated cellulose fibers containing a phosphorus-based flame retardant. The natural cellulose fibers and the regenerated cellulose fibers are not particularly limited, and may be those mentioned above.

The phosphorus-based flame retardant is not particularly limited, and may be a phosphoric acid ester-based compound, a halogenated phosphoric acid ester-based compound, a condensed phosphoric acid ester-based compound, a polyphosphoric acid salt-based compound, a polyphosphoric acid ester-based compound, or the like.

The flame-retardant cellulose fibers may be flame-retardant regenerated cellulose fibers, or flame-retardant rayon fibers, from the viewpoint of, for example, ease of dyeing, flame retardancy, and cost. The flame-retardant rayon fibers are not particularly limited, and may be, for example, commercially available products such as “LenzingFR” manufactured by Lenzing AG.

The flame-retardant cellulose fibers may contain phosphorus derived from the phosphorus-based flame retardant in an amount of 0.5 to 2.0% by mass, or 0.8 to 1.8% by mass, from the viewpoint of, for example, flame retardancy and fiber strength, but there is no particular limitation thereto.

The single fiber fineness of the flame-retardant cellulose fibers is not particularly limited, and may be 1 to 20 dtex, or 1.5 to 15 dtex, from the viewpoint of strength. The fiber length of the flame-retardant cellulose fibers is not particularly limited, and may be 38 to 127 mm, or 38 to 76 mm, from the viewpoint of strength.

The aramid fibers may be either para-aramid fibers or meta-aramid fibers. The single fiber fineness of the aramid fibers is not particularly limited, and may be 1 to 20 dtex, or 1.5 to 15 dtex, from the viewpoint of strength. The fiber length of the aramid fibers is not particularly limited, and may be 38 to 127 mm, or 38 to 76 mm, from the viewpoint of strength.

The flame-retardant fabric contains 20% by mass or more and less than 40% by mass of the silica-containing cellulose fibers, 25 to 55% by mass of the flame-retardant cellulose fibers, and 10 to 50% by mass of the aramid fibers. If the content of the silica-containing cellulose fibers is less than 20% by mass or 40% by mass or more, the flame retardancy is poor. As a result of the aramid fibers, the flame-retardant cellulose fibers, and the silica-containing cellulose fibers being used in combination and the amount of the silica-containing cellulose fibers being limited to a predetermined range, a fabric that exhibits high flame retardancy is obtained. The flame-retardant fabric may contain 20 to 38% by mass of the silica-containing cellulose fibers, 25 to 50% by mass of the flame-retardant cellulose fibers, and 20 to 50% by mass of the aramid fibers, and may contain 20 to 35% by mass of the silica-containing cellulose fibers, 28 to 45% by mass of the flame-retardant cellulose fibers, and 25 to 45% by mass of the aramid fibers.

The flame-retardant fabric may contain silica derived from silica-containing cellulose fiber in an amount of 3.0 to 9.0% by mass, 3.3 to 8.0% by mass, or 3.6 to 7.5% by mass, from the viewpoint of flame retardancy and fabric strength.

The flame-retardant fabric may contain phosphorus derived from the flame-retardant cellulose fibers in an amount of 0.3 to 1.1% by mass, 0.4 to 1.0% by mass, or 0.5 to 0.9% by mass, but there is no particular limitation thereto. In this specification, the content of phosphorus in the flame-retardant fabric or the flame-retardant cellulose fibers can be measured using a fluorescent X-ray analysis method.

The flame-retardant fabric may contain other fibers to the extent that they do not inhibit the purposes and effects of one or more embodiments of the present invention. The other fibers may be, for example, cellulose fibers other than the silica-containing cellulose fibers and the flame-retardant cellulose fibers, or fibers such as nylon fibers that can be dyed with reactive dyes. The flame-retardant fabric may contain other fibers in an amount of 10% by mass or less, 8% by mass or less, or 1% by mass or less.

The single fiber fineness of the other fibers is not particularly limited, and may be 1 to 20 dtex, or 1.5 to 15 dtex, from the viewpoint of strength. The fiber length of the other fibers is not particularly limited, and may be 38 to 127 mm, or 38 to 76 mm, from the viewpoint of strength.

The form of the flame-retardant fabric is not particularly limited, and may be, for example, a woven fabric, a knitted fabric, or the like. The structure of the woven fabric is not particularly limited, and may be three basic weaves such as plain weave, twill weave, or satin weave, or may be patterned weave using a special weaving machine such as a dobby machine or a Jacquard machine. The structure of the knitted fabric is not particularly limited, and may be any of circular knitting, weft knitting, and warp knitting. The flame-retardant fabric may be a woven fabric, or a twill woven fabric, from the viewpoint of excellent durability.

The basis weight of the flame-retardant fabric is not particularly limited, and may be 200 to 400 g/m2, 220 to 380 g/m2, or 250 to 350 g/m2, from the viewpoint of, for example, texture and flame retardancy.

The flame-retardant fabric has excellent flame retardancy, and may have a char length of 20 mm or less, or 18 mm or less, as measured in a flammability test based on GB/T 5455-2014 defined in GB8965.1-2020. The flame-retardant fabric has excellent flame retardancy, and may have an afterflame time of 2.0 seconds or less, 1.0 seconds or less, or 0 seconds, as measured in a flammability test based on GB/T 5455-2014 defined in GB8965.1-2020. The flame-retardant fabric has excellent flame retardancy, and may have an afterglow time of 4.0 seconds or less, 3.0 seconds or less, 2.0 seconds or less, 1.0 seconds or less, or 0 seconds, as measured in a flammability test based on GB/T 5455-2014 defined in GB8965.1-2020. GB8965.1-2020 is Chinese National Standard regarding flame-retardant protective clothing.

The flame-retardant fabric has excellent washing-durable flame retardancy, and may have a char length of 29 mm or less, 28 mm or less, 27 mm or less, 26 mm or less, or 25 mm or less, as measured in a flammability test based on GB/T 5455-2014 defined in GB8965.1-2020 after being washed 50 times according to GB/T 17596-1998. The flame-retardant fabric has excellent washing-durable flame retardancy, and may have an afterflame time of 2.0 seconds or less, 1.0 seconds or less, or 0 seconds, as measured in a flammability test based on GB/T 5455-2014 defined in GB8965.1-2020 after being washed 50 times according to GB/T 17596-1998. The flame-retardant fabric has excellent washing-durable flame retardancy, and may have an afterglow time of 4.0 seconds or less, 3.0 seconds or less, 2.0 seconds or less, 1.5 seconds or less, or 1.0 seconds or less, as measured in a flammability test based on GB/T 5455-2014 defined in GB8965.1-2020 after being washed 50 times according to GB/T 17596-1998.

The flame-retardant fabric can be dyed in one bath using a reactive dye.

The reactive dye may be known reactive dyes. The chemical structure of the reactive dye may be, for example, pyrazolone azo-based, benzene azo-based, naphthalene azo-based, pyridone azo-based, anthraquinone-based, metal complex salt-type monoazo-based, formazan-based, phthalocyanine-based, disazo-based, azine-based, dioxazine-based, or the like. The reactive group of the reactive dye may be, for example, a sulfatoethyl sulfone group, a vinyl sulfone group, a dichlorotriazine group, a monochlorotriazine group, a monofluorotriazine group, a trichloropyrimidine group, or the like. The reactive groups may be used alone or in a combination of two or more. The reactive dye is not particularly limited, and may be, for example, commercially available products such as “Remazol (registered trademark)” manufactured by DyStar or “NOVACRON (registered trademark)” manufactured by HANTSMAN.

The dye solution (dyeing bath) may be a water mixture liquid containing the reactive dye. The content of the reactive dye is not particularly limited, and may be 0.01 to 10% owf with respect to the fabric. The dye solution usually contains a dyeing aid such as glauber's salt and soda ash. The content of the glauber's salt in the dye solution is not particularly limited, and may be, for example, 50 to 200 g/L. The content of the soda ash in the dye solution is not particularly limited, and may be, for example, 5 to 40 g/L.

In the dyeing process that performs dyeing using the reactive dye, for example, it is preferable that a fabric is immersed in a dyeing bath containing the reactive dye at 40 to 50° C. for 5 to 10 minutes, then glauber's salt is added and the mixture is kept at 40 to 50° C. for 5 to 10 minutes, the temperature is increased to 60 to 80° C., soda ash is added, and the fabric is dyed at 60 to 80° C. for 30 to 90 minutes. Subsequently, for example, in order to improve the fastness to rubbing, the fabric may be washed with water at 30 to 40° C. 1 to 4 times at intervals of 5 to 10 minutes, further washed (soaped) with hot water at 60 to 80° C. 1 to 3 times at intervals of 10 to 15 minutes, neutralized with acetic acid at 30 to 40° C. for 5 minutes, washed with water at 30 to 40° C. for 5 to 10 minutes, and subjected to color fixation at 50 to 60° C. for 10 to 15 minutes. The soaping agent may be an appropriate soaping agent for reactive dyes, and is not particularly limited. For example, commercially available soaping agents such as “Lipotol RK” manufactured by Nicca Chemical Co., Ltd. may be used.

### Work Clothing

In one or more embodiments of the present invention, the flame-retardant fabric can be favorably used as a fabric for work clothing required to have flame retardancy. In one or more embodiments of the present invention, the work clothing can be produced using the flame-retardant fabric described above through a known sewing method. In one or more embodiments of the present invention, the flame-retardant fabric has excellent flame retardancy, and thus the work clothing also has excellent flame retardancy. Also, since the flame-retardant fabric has excellent flame retardancy and texture even after being repeatedly washed, the work clothing maintains its flame retardancy and texture even after being repeatedly washed. In one or more embodiments of the present invention, the work clothing can be used in any field of work in which flame retardancy is required. For example, the work clothing can be used as protective clothing (fire-fighting clothing) to be worn by a firefighter, protective clothing to be worn in workplaces in the fields of petroleum, petrochemistry, coal mining, electric power, welding, and the like in which accidents such as a fire may happen, and work clothing to be worn in workplaces in the fields of metalwork and the like in which accidents such as a dust explosion are likely to happen, but there is no particular limitation thereto.

### EXAMPLES

Hereinafter, one or more embodiments of the present invention will be more specifically described by way of examples. However, one or more embodiments of the present invention are not limited to the following examples.

The measurement and evaluation methods used in the examples and comparative examples are as follows.

### Silica Content

Through SEM-EDS analysis (using a tabletop scanning electron microscope and energy dispersive X-ray analyzer JCM-6000PLUS, manufactured by JEOL Ltd.), 5 g of a fiber was analyzed under the following conditions to determine the silica content from the approximate mass of elements.

### Measuring Conditions

Accelerating voltage: 15.0 kV
PHA mode: T3
Energy range: 0 to 20 keV

### Content of Phosphorus

The content of phosphorus in a sample (fiber) was measured by a fluorescent X-ray analysis method using an X-ray fluorescence analyzer (“SEA2210A” manufactured by SII NanoTechnology Inc.). First, standard samples, each having a known phosphorus content, were prepared to measure the fluorescent X-ray intensity of phosphorus, and the results were plotted to obtain a calibration curve. Next, the fluorescent X-ray intensity of phosphorus of a sample was measured. The content of phosphorus in the sample was calculated by comparing the measured intensity with the calibration curve.

### Flame Retardancy

A flammability test was conducted based on GB/T 5455-1997 defined in GB8965.1-2020 to measure the char length, the afterflame time, and the afterglow time of the fabric.

Flame Retardancy after Washing

After being washed 50 times according to GB/T 17596-1998, a flammability test was conducted based on GB/T 5455-1997 defined in GB8965.1-2020 to measure the char length, the afterflame time, and the afterglow time of the fabric.

Dyeability with Reactive Dye

Using a dye solution containing NOVACRON (registered trademark) SUPER Black R (manufactured by HANTSMAN), which is a reactive dye, the fabric was immersed in the dye solution containing the reactive dye at 40° C. for 5 minutes, then glauber's salt was added to a concentration of 120 g/L, and the temperature was increased at 3° C./min to 80° C. After 5 minutes, soda ash was added, and the fabric was dyed at 80° C. for 60 minutes. The amount of reactive dye was 5% owf. Subsequently, in order to improve the fastness to rubbing, the fabric was washed with water, soaped, neutralized with acetic acid, and then washed with water again. “Lipotol RK” manufactured by Nicca Chemical Co., Ltd. was used as the soaping agent. Dyeability in one bath using the reactive dye was visually evaluated.
A: Acceptable, plain black
N: Not acceptable, wood grain-like pattern

The following fibers were used in the examples and comparative examples.
Flame-retardant rayon fiber: “LenzingFR” manufactured by Lenzing AG, containing phosphorus-based flame retardant, single fiber fineness 2.2 dtex, fiber length 51 mm, content of phosphorus 3.3% by mass
Silica rayon fiber A: “Silica Rayon” manufactured by Shandong Helon Polytex Chemical Fiber Co., Ltd., China, single fiber fineness 2.2 dtex, fiber length 51 mm, silica content 19.5% by mass
Silica rayon fiber B: “FR CORONA (registered trademark)” manufactured by Daiwabo Rayon Co., Ltd., single fiber fineness 2.2 dtex, fiber length 51 mm, silica content 17.2% by mass
Meta-aramid fiber: “Newstar (registered trademark)” manufactured by Yantai Tayho Advanced Materials, single fiber fineness 1.7 dtex, fiber length 51 mm
Para-aramid fiber: “Taparan (registered trademark)” manufactured by Yantai Tayho Advanced Materials, single fiber fineness 1.7 dtex, fiber length 51 mm
Modacrylic fiber A: manufactured by Kaneka Corporation, acrylic fiber that is constituted by acrylic copolymer containing 49.5% by mass of acrylonitrile, 49.5% by mass of vinyl chloride, and 1.0% by mass of sodium styrenesulfonate, and that contains 9.1% by mass of antimony trioxide with respect to the total fiber mass, single fiber fineness 1.7 dtex, fiber length 51 mm
Modacrylic fiber B: manufactured by Kaneka Corporation, acrylic fiber that is constituted by acrylic copolymer containing 49.5% by mass of acrylonitrile, 49.5% by mass of vinylidene chloride, and 1.0% by mass of sodium styrenesulfonate, and that contains 5.1% by mass of antimony trioxide with respect to the total fiber mass, single fiber fineness 1.7 dtex, fiber length 51 mm

### Examples 1 to 5 and Comparative Examples 1 to 7

The fibers shown in Table 1 below were blended in the amounts shown in Tables 1 and 2 below to produce spun yarns of the cotton count Nos. shown in Table 1 below. The spun yarns were used to produce jersey-knitted fabrics with the basis weights shown in Table 1 below using a common manufacturing method.

The flame retardancy, the flame retardancy after washing, and the dyeability of the fabrics obtained in Examples 1 to 5 and Comparative Examples 1 to 7 were measured as described above. Table 1 below shows the results.

TABLE 1

| | | Examples | | | | | Comparative Examples | | | | | | |
|---|---|---|---|---|---|---|---|---|---|---|---|---|---|
| | | 1 | 2 | 3 | 4 | 5 | 1 | 2 | 3 | 4 | 5 | 6 | 7 |
| Amount | Silica-containing rayon | 30 | 35 | 0 | 0 | 20 | 40 | 40 | 40 | 18 | 0 | 0 | 0 |
| (% by mass) | fiber A | | | | | | | | | | | | |
| | Silica-containing rayon | 0 | 0 | 30 | 35 | 0 | 0 | 0 | 0 | 0 | 0 | 0 | 0 |
| | fiber B | | | | | | | | | | | | |
| | Flame-retardant rayon | 30 | 30 | 30 | 30 | 40 | 30 | 40 | 35 | 42 | 30 | 30 | 30 |
| | fiber | | | | | | | | | | | | |
| | Para-aramid fiber | 20 | 30 | 20 | 30 | 20 | 15 | 10 | 20 | 20 | 20 | 30 | 20 |
| | Meta-aramid fiber | 20 | 5 | 20 | 5 | 20 | 15 | 10 | 5 | 20 | 20 | 5 | 20 |
| | Modacrylic Fiber A | 0 | 0 | 0 | 0 | 0 | 0 | 0 | 0 | 0 | 30 | 35 | 0 |
| | Modacrylic Fiber B | 0 | 0 | 0 | 0 | 0 | 0 | 0 | 0 | 0 | 0 | 0 | 30 |
| Spun yarn | Cotton count No. | 18/1 | 18/1 | 18/1 | 18/1 | 18/1 | 18/1 | 18/1 | 18/1 | 18/1 | 18/1 | 18/1 | 18/1 |
| Fabric | Basis weight (g/m²) | 120 | 114 | 126 | 102 | 120 | 116 | 121 | 125 | 121 | 120 | 125 | 121 |
| | Silica content | 5.9 | 6.8 | 5.2 | 6 | 3.9 | 7.8 | 7.8 | 7.8 | 3.5 | 0 | 0 | 0 |
| | (% by mass) | | | | | | | | | | | | |
| Flame | Char length (mm) | 12 | 14 | 14 | 15 | 18 | Completely burned | | | 21 | 21 | 22 | 42 |
| retardancy | Afterflame time (sec) | 0.0 | 0.0 | 0.0 | 0.0 | 0.0 | | | | 0.0 | 0.0 | 0.0 | 0.0 |
| | Afterglow time (sec) | 0.0 | 1.0 | 1.2 | 1.8 | 0.0 | | | | 0.0 | 0.0 | 3.7 | 1.0 |
| Flame | Char length (mm) | 22 | 26 | 28 | 28 | 22 | | | | 33 | 30 | 34 | 55 |
| retardancy | Afterflame time (sec) | 0.0 | 0.0 | 0.0 | 0.0 | 0.0 | | | | 0.0 | 0.0 | 0.0 | 0.0 |
| after washed | Afterglow time (sec) | 1.0 | 1.3 | 1.4 | 2.0 | 1.0 | | | | 1.1 | 1.1 | 3.9 | 2.5 |
| 50 times | | | | | | | | | | | | | |
| Dyeability | One-bath dyeing with | A | A | A | A | A | A | A | A | A | N | N | N |
| | reactive dye | | | | | | | | | | | | |

As can be seen from Table 1 above, the fabrics in the examples were able to be dyed in one bath using the reactive dye and had shorter char lengths as measured in a flammability test based on GB/T 5455-1997 defined in GB8965.1-2020 than those of the fabrics of Comparative Examples 5 to 7 using modacrylic fibers, indicating that the fabrics in the examples have higher flame retardancy.

The fabrics of Comparative Examples 1 to 3 with a high content of silica-containing rayon fibers were completely burned in a flammability test based on GB/T 5455-1997, indicating that the fabrics have extremely poor flame retardancy. The fabric of Comparative Example 4 with a low content of silica-containing rayon fibers had a similar char length as measured in a flammability test based on GB/T 5455-1997 to those of the fabrics of Comparative Examples 5 to 7 using modacrylic fibers.

One or more embodiments of the present invention may include, without limitation, the following embodiments.
[1] A flame-retardant fabric containing 20% by mass or more and less than 40% by mass of silica-containing cellulose fibers, 25 to 55% by mass of flame-retardant cellulose fibers containing a phosphorus-based flame retardant, and 10 to 50% by mass of aramid fibers.
[2] The flame-retardant fabric according to [1], wherein the silica-containing cellulose fibers include silica-containing rayon fibers.
[3] The flame-retardant fabric according to [1] or [2], wherein the flame-retardant cellulose fibers include flame-retardant rayon fibers.
[4] The flame-retardant fabric according to any one of [1] to [3], wherein the aramid fibers include one or more of fibers selected from the group consisting of para-aramid fibers and meta-aramid fibers.
[5] The flame-retardant fabric according to any one of [1] to [4], having a char length of 20 mm or less as measured in a flammability test based on GB/T 5455-2014 defined in GB8965.1-2020.
[6] The flame-retardant fabric according to any one of [1] to [5], wherein the silica-containing cellulose fibers contain silica in an amount of 10 to 30% by mass.
[7] The flame-retardant fabric according to any one of [1] to [6], wherein the flame-retardant fabric contains silica derived from the silica-containing cellulose fibers in an amount of 3.0 to 9.0% by mass.
[8] The flame-retardant fabric according to any one of [1] to [7], wherein at least one type of fibers selected from the group consisting of the silica-containing cellulose fibers, the flame-retardant cellulose fibers, and the aramid fibers have a fiber length of 38 to 127 mm.
[9] Work clothing containing the flame-retardant fabric according to any one of [1] to [8].

One or more embodiments of the invention may be embodied in other forms without departing from the spirit or essential characteristics thereof. One or more embodiments disclosed in this application are to be considered in all respects as illustrative and not limiting. The scope of one or more embodiments of the invention is indicated by the appended claims rather than by the foregoing description, and all changes which come within the meaning and range of equivalency of the claims are intended to be embraced therein.

Although the disclosure has been described with respect to only a limited number of embodiments, those skilled in the art, having benefit of this disclosure, will appreciate that various other embodiments may be devised without departing from the scope of the present disclosure. Accordingly, the scope of one or more embodiments of the invention should be limited only by the attached claims.

What is claimed is:

1. A flame-retardant fabric comprising:
20% by mass or more and less than 40% by mass of silica-containing cellulose fibers;
25 to 55% by mass of flame-retardant cellulose fibers containing a phosphorus-based flame retardant; and
10 to 50% by mass of aramid fibers.

2. The flame-retardant fabric according to claim 1, wherein the silica-containing cellulose fibers include silica-containing rayon fibers.

3. The flame-retardant fabric according to claim 1, wherein the flame-retardant cellulose fibers include flame-retardant rayon fibers.

4. The flame-retardant fabric according to claim 1, wherein the aramid fibers include one or more of fibers selected from the group consisting of para-aramid fibers and meta-aramid fibers.

5. The flame-retardant fabric according to claim 1, having a char length of 20 mm or less as measured in a flammability test based on GB/T 5455-2014 defined in GB8965.1-2020.

6. The flame-retardant fabric according to claim 1, wherein the silica-containing cellulose fibers comprise silica in an amount of 10 to 30% by mass.

7. The flame-retardant fabric according to claim 1, wherein the flame-retardant fabric comprises silica derived from the silica-containing cellulose fibers in an amount of 3.0 to 9.0% by mass.

8. The flame-retardant fabric according to claim 1, wherein at least one type of fibers selected from the group consisting of the silica-containing cellulose fibers, the flame-retardant cellulose fibers, and the aramid fibers have a fiber length of 38 to 127 mm.

9. Work clothing comprising the flame-retardant fabric according to claim 1.

10. The work clothing according to claim 9, wherein the silica-containing cellulose fibers include silica-containing rayon fibers.

11. The work clothing according to claim 9, wherein the flame-retardant cellulose fibers include flame-retardant rayon fibers.

12. The work clothing according to claim 9, wherein the aramid fibers include one or more of fibers selected from the group consisting of para-aramid fibers and meta-aramid fibers.

13. The work clothing according to claim 9, having a char length of 20 mm or less as measured in a flammability test based on GB/T 5455-2014 defined in GB8965.1-2020.

14. The work clothing according to claim 9, wherein the silica-containing cellulose fibers comprise silica in an amount of 10 to 30% by mass.

15. The work clothing according to claim 9, wherein the flame-retardant fabric comprises silica derived from the silica-containing cellulose fibers in an amount of 3.0 to 9.0% by mass.

16. The work clothing according to claim 9, wherein at least one type of fibers selected from the group consisting of the silica-containing cellulose fibers, the flame-retardant cellulose fibers, and the aramid fibers have a fiber length of 38 to 127 mm.
